(19) United States
(12) Patent Application Publication
(10) Pub. No.: US 2004/0094186 A1
(43) Pub. Date: May 20, 2004

(54) Method and apparatus for uniform treatment of objects in liquids

(76) Inventor: Igor Ivanov, Dublin, CA (US)

Correspondence Address: MOLLIE LETTANG, CONLCY ROSE, P.C., P.O. BOX 684908, AUSTIN, TX, 78768-4908, US

(21) Appl. No.: 10/299,074

(22) Filed: Nov. 19, 2002

(51) Int. Cl. B08B 1/02

(52) U.S. Cl. 134/32; 134/34; 134/121; 134/149; 134/157; 134/902

(57) ABSTRACT

The apparatus of the invention comprises a sealable working chamber that contains an object holder, in which the object can be maintained during treatment in a moveable floating state, e.g., during a cleaning cycle for access of the cleaning fluid to both upper and lower surfaces of the object without contact of the object edges with jaws of the clamping mechanism. For this purpose, liquid vortex-generation means are formed in the object holder. According to one embodiment, the liquid vortex-generation means comprise a number of openings formed under the lower surface of the object placed into a recess formed in the object holder. Each vortex generation opening is substantially perpendicular to the plane of the object and contains one or a plurality of nozzles arranged tangentially to the wall of the opening so that a vortex is generated in each opening when the liquid is ejected through the nozzles into the opening for further delivery to the recess. Since the object is freely supported, the vortexes formed by the streams of the liquid cause the object to float and to rotate due to interaction of the vortexes with the object via viscous friction.

### FIELD OF THE INVENTION

The present invention relates to a method and apparatus for uniform treatment of objects in liquids, in particular, to a method and apparatus for processing semiconductor wafers in liquids. The invention may find application in semiconductor industry on such operations as electroless deposition, chemical mechanical polishing, cleaning or coating semiconductor substrates, or the like.

### BACKGROUND OF THE INVENTION

Manufacturing of semiconductor devices, in particular integrated circuits having multiple-layered structures with various metal and non-metal layers laminated on a semiconductor substrate, typically involves application of several metal layers onto a substrate or onto other previously deposited layers. Formation of laminated layers on the surfaces of semiconductor substrates may be accompanied by a number of processes associated with treatment of substrates in liquids, such as electroplating, electroless plating, coating by spinning, chemical mechanical polishing, cleaning, etc.

For example, International Patent Application Publication WO 02/063067 published in 2002 (Applicant Hiroshi Sato) discloses a method and apparatus for electroless deposition with various processes performed in one and the same working chamber. The apparatus comprises a system of moveable cassettes with semiconductor wafers transferable between the cassette station and the processing station. The entire system is enclosed in a casing through which a cleaning gas is blown. The processing station, which is located in an upstream position of the cleaning gas flow, contains a plurality of electroless deposition units to which the wafers are transferred by mechanical arms operating between the wafer transportation system and the deposition units.

Each wafer deposition unit has a rectangular box-like housing with an input/output port for the transportation mechanism, which penetrates the housing and leaves the housing through a gate valve. The housing contains a cup shaped hood that can be raised or descended by a drive unit.

Located in the central part of the housing is a rotary drive for a rotary table installed in the housing at a predetermined distance from the motor. A first hollow output shaft of the rotary motor contains a second hollow shaft. The first shaft is connected to a vibration mechanism that may transmit vibrations to the first shaft.

The wafer W is supported by a chuck with tiltable clamping cams. The second shaft supports control nozzles arranged under the periphery of the wafer, when the latter is installed in the chuck. These nozzles are inclined at an acute angle to the periphery of the wafer and can be used for the supply of inert gas or pure water to the lower wafer surface in order to prevent the flow of electroless solution to the rear surface of the wafer around the wafer edges.

Located between the rotating table and rear side of the wafer W is a hollow disk with the nozzle opening. The interior of the disk is connected to the pipe which passes through the second shaft for the supply of a cleaning solution. When this solution is ejected through the nozzle openings of the disk, it can lift the wafer.

On the other hand, a neutral gas flow passage is formed between the first shaft and the second shaft for blowing a neutral gas over the surface of the rotating table from the center of the table towards its periphery. The gas is removed through openings in the bottom portion of the cup-shaped hood. This gas flow is used for cleaning the wafer surface from contaminants.

Nozzles for the supply of a reducing agent solution and nozzles for the supply of electroless deposition solution with metal ions are arranged above the wafer in the chuck.

For electroless deposition, the wafer W is placed into clamping cams of the chuck, the table is driven into rotation, the clamping cams are tilted under the effect of the centrifugal forces and firmly clamp the wafer W in the chuck. The process is then carried out in the single working chamber of each processing unit with the following sequential steps: 1) preliminary cleaning, 2) supply of the additive agent, 3) supply of the hydrochloric acid copper solution, 3) measurement of the deposited film thickness, repetition of steps 2), 3) 4) until a predetermined thickness is reached, 5) final cleaning.

A main disadvantage of the aforementioned system is that for processing in fluids, the wafer W is positively clamped between the cams of the chuck. Points of physical contact between the clamping cams and edges of the wafer are not treated by the working medium and contributes to accumulation of contaminants.

In order to improve uniformity of treatment and to eliminate the above disadvantages, it was proposed to clamp the substrate between rollers and to rotate the substrate during treatment. For example, U.S. Pat. No. 6,405,739 issued in 2002 to Yu-tsai Liu discloses a spin chuck using at least three clamping rollers for clamping a substrate during the rotation of the substrate. The clamping rollers are driven by a planetary gear transmission mechanism that is on a rotatable body. The final rotation speed of the substrate is determined by the cooperation of the rotation speeds of the clamping rollers and the body. The spin chuck is capable of providing simultaneous dual-sided processing, and the angular velocity and angular acceleration of the spin chuck have a wide range of adjustment.

A disadvantage of the apparatus of U.S. Pat. No. 6,405,739 consists of the fact that, even though the substrate is rotated with a controlled speed and is treated simultaneously from both sides, it still has physical contact between the edges of the substrate and the supporting rollers. Furthermore, the apparatus requires the use of a complicated mechanical drive system with planetary transmission of movements.

An attempt has been made in U.S. Pat. No. 6,435,200 issued in 2000 to K. Langen to solve the above problems by utilizing jets of liquid ejected from beneath a substrate for maintaining it in floating state during the treatment. In this apparatus, nozzles inclined radially outwardly and aimed at the edges of the substrate from underneath the substrate are formed in the substrate support surface. The liquid is applied to a first surface, flows essentially radially to the outside to the peripheral-side edge of the wafer-shaped article and around this edge onto the second surface, the liquid wetting a defined section near the edge on the second surface and thereupon being removed from the wafer-shaped article. As mentioned by the inventors of aforementioned U.S. Pat. No. 6,435,200 themselves, their method and apparatus are intended for treating only specific areas, i.e., the areas near the edge of the substrate and therefore other areas of the substrate surface remain unaffected. Therefore the aforementioned method and apparatus are inapplicable for uniform treatment of the substrate over its entire surface. In any case, a certain stagnation zone will always remain on the lower surface in the central areas of the substrate.

U.S. Pat. No. 5,259,407 issued in 1993 to J. Tsuchida discloses a wafer surface treatment apparatus and method used in the apparatus including a treatment tank with a cylindrical inside with a bottom, a circular recess formed in the bottom of the tank, a plurality of lower fluid holes opened in the recess, and a horizontally long opening provided at lower part of the side wall of the tank. A movable wall is tightly but slidably installed in the cylindrical inside of the tank so that the movable wall forms a closed room with the recess when it comes into contact with the bottom of the tank. Also, a plurality of upper fluid holes are provided so as to communicate with the closed room, and a rinsing water and washing liquid supply/discharge device is connected to the upper and lower fluid holes. Surfaces of a semiconductor wafer is treated by placing one wafer in the recess, closing the opening, and then spouting a fluid (washing liquid and rinsing water) onto the both sides of the wafer repeatedly while the wafer is floating and rotated by a spouting force of the fluid in the closed room. The fluid used in the treatment is discharged from the tank while the treatment is being performed.

The washing liquid is supplied with a pressure of about 2 Kg/cm². Accordingly, the wafer floats from the bottom of the recess by being lifted by the liquid from the below and is also pressed down by the liquid from the above. Thus, the wafer keeps the floating state in the closed room without making contact with the upper surface of the recess and the lower face of the movable wall. In this state, the wafer receives the fluid spout from the above and also from the below, thus being cleaned uniformly.

In addition, the washing liquid may be supplied from the inclined fluid holes in the direction, in which the circumferential component of a force is generated onto the wafer. As a result, the wafer is rotated by the liquid pressure supplied form the above and from the below.

A disadvantage of such a jet-type liquid supply system is that it requires supply of liquids under relatively high pressures, which lead to discontinuity of flows. High-speed jets make it difficult to control flows and flow velocities and the process may be accompanied by various undesired phenomena, e.g., such as cavitation caused by turbulent conditions. Therefore the devices of the type described in U.S. Pat. No. 5,259,407 may find only a very limited application. For example, they are inapplicable to electroless processes for the formation of super-thin films or for cleaning wafer with delicate structures formed on the preceding process because such structures can be damaged.

### OBJECTS AND SUMMARY OF THE INVENTION

It is an object of the present invention to provide a method and apparatus for processing an object in a continuous liquid medium without physical contact of the object with any parts of the apparatus during treatment. Another object is to impart rotation to the object from a force generated by the same liquid medium and within the volume of the medium which is used for treatment of the substrate. Another object is to provide a method and system for treatment of an object uniformly from all sides without the use of high-pressure jets of liquids aimed at the surfaces of the treated object and without discontinuity of flows in the working medium. Another object is to provide a simple and inexpensive mechanism of rotation of the objects during treatment. A further object is to provide a method and apparatus applicable for the formation of super-thin coatings and without damaging delicate surface structures in the processes. It is another object is to generate a vortex or vortexes within the working medium for rotating an object via viscous friction between the working medium and the surface of the object.

The apparatus of the invention comprises a sealable working chamber that contains an object holder, in which the object can be maintained during treatment in a moveable floating state, e.g., during a cleaning cycle for access of the cleaning fluid to both upper and lower surfaces of the object without contact of the object's edges with jaws of the clamping mechanism. For this purpose, liquid vortex-generation means are formed in the object holder. According to one embodiment, the liquid vortex-generation means comprise a number of openings formed under the lower surface of the object placed into a recess formed in the object holder. Each vortex generation opening is substantially perpendicular to the plane of the object and contains one or a plurality of nozzles arranged tangentially to the wall of the opening so that a vortex is generated in each opening when the liquid is ejected through the nozzles into the opening for further delivery to the recess. Since the object is freely supported, the vortexes formed by the streams of the liquid cause the object to float and to rotate, so that the cleaning liquid will flow around the object reaching all points on the object's surface. By arranging a plurality of vortex-generation openings with opposite directions of vortex rotations, it is possible to switch direction of rotation of the object during cleaning. In a second embodiment, the vortex-generation nozzles are arranged in a large-diameter annular groove, which is located close to the substrate periphery but does not go beyond the substrate periphery. The pressure with which the vortex can act onto the lower surface of the substrate can be adjusted by a screw with a large smooth head which controls interaction of the vortex with the lower surface of the substrate via viscous friction. During treatment, e.g., cleaning of the substrate in a freely floating state, the substrate is free of contact with other parts of the object holder and therefore provides access of the cleaning solution to all points on the surface of the treated object.

### BRIEF DESCRIPTION OF THE DRAWINGS

FIG. 1 is a schematic vertical cross-sectional view of an apparatus according to one embodiment of the invention.

FIG. 2 is top view of the substrate holder illustrating arrangement of six vortex generation openings in the bottom of the recess.

FIG. 3 illustrates a vortex generation opening with a pressure control mechanism in the form of a screw with a flat head.

FIG. 4 shows another embodiment of a vortex generation mechanism in the form of an annular groove with an outer diameter slightly smaller than the diameter of the recess.

FIG. 5 is a side sectional view of the apparatus according to another embodiment of the invention, in which switchable vortex generation means are formed in a blind cylindrical opening in the center of a recess.

FIG. 6 is a top view of the device of FIG. 5.

FIG. 7 is a top view on the substrate illustrating generation of a torque applied to the substrate under the effect of two diametrically opposite vortex generation openings.

FIG. 8 shows distribution of pressure applied from the processing liquid to the lower surface of the substrate across the diameter of the substrate for the device of embodiment shown in FIG. 4.

FIG. 9 shows distribution of pressure applied from the processing liquid to the lower surface of the substrate across the diameter of the substrate for the device of embodiment shown in FIGS. 5 and 6.

### DETAILED DESCRIPTION OF THE INVENTION

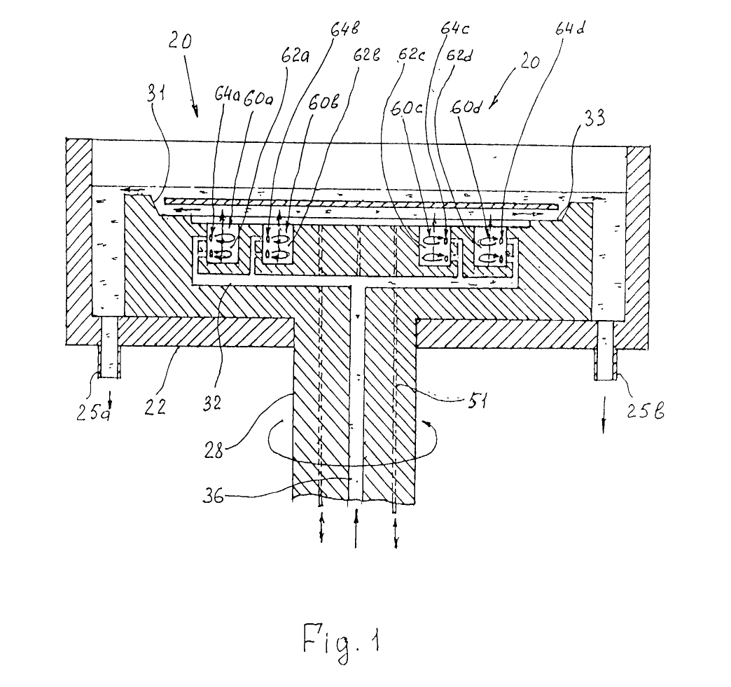

FIG. 1 is a schematic vertical cross-sectional view of an apparatus of the invention. The invention will be illustrated with reference to an electroless deposition apparatus only as an example since the principle of the invention is applicable to treatment of other objects with other liquids.

In the embodiment of the apparatus shown in FIG. 1, the substrate W is placed and held in the holder 20 without the use of any mechanical clamping means such as the edge-grip mechanism. In other words, the holder body 24 has on its upper side a tapered bore with a flat annular shoulder or substrate seat 33 on the bottom of the tapered bore 31. The tapered bore 31 has a diameter exceeding the diameter of the substrate W and is needed for stabilizing position of the substrate in a floating state during processing. A shallow recess 26 is formed underneath the shoulder 33, and vortex-generation means are formed in the bottom of the recess 26 under the lower surface of the substrate W, when the substrate is supported by the shoulder 33. Although four such vortex generation means 60a, 60b, 60c, 60d are shown in FIG. 1, the number of vortexes and their distribution over the surface of the recess bottom can be different. Each vortex generation means comprises an opening (62a, 62b, 62c, 62d) substantially perpendicular to the plane of the substrate W, when the latter is placed into the holder 20. Each opening (62a, 62b, 62c, 62d) has a round cross section and contains a plurality of nozzles (64a, 64b, 64c, 64d) arranged tangentially to the cylindrical walls of the openings so that, when the liquid is ejected into the openings through the nozzles, it flows in a circular path and thus generates vortexes. Only two nozzles are shown in each opening, though the number of the nozzles in each opening may be different.

Reference numeral 51 designates a liquid input channel, and reference numeral 36 designates a pusher pin for lifting the substrate W during loading/unloading.

Reference numerals 25a and 25b designate outlet opening for removal of the liquid from the bottom of the enclosure 22.

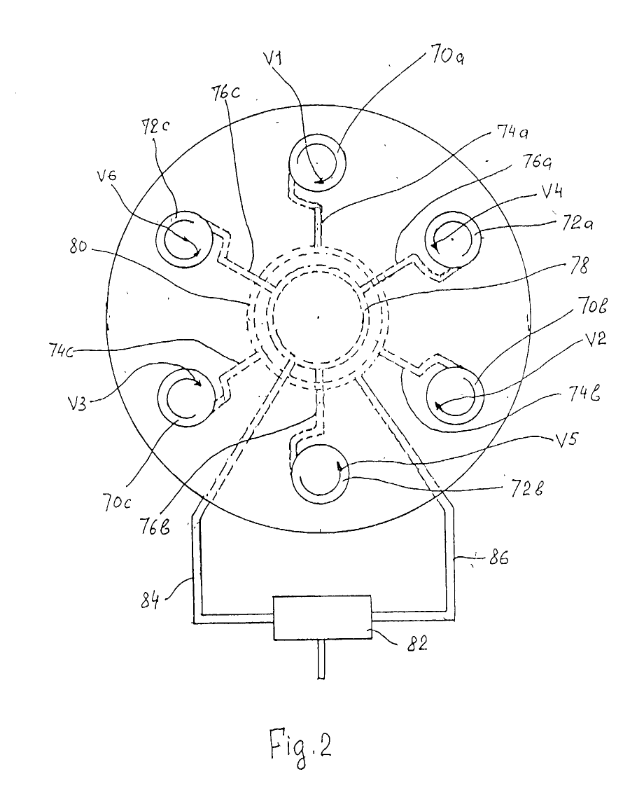

FIG. 2 is top view of the substrate holder illustrating arrangement of six vortex generation openings in the bottom of the recess 26. Three openings 70a, 70b, and 70c generate vortexes rotating in a clockwise direction shown by the arrows V1, V2, and V3, respectively. Three other openings 72a, 72b, and 72c, which are arranged between the openings 70a, 70b, and 70c, generate vortexes rotating in a counterclockwise direction shown by the arrows V4, V4, and V6, respectively. In FIG. 2, reference numerals 74a, 74b, and 74c designate channels that supply a heating/cooling or cleaning liquid to the openings 70a, 70b, and 70c, while reference numerals 76a, 76b, and 76c designate channels that supply a heating/cooling or cleaning liquid to the openings 72, 72b, and 72c.

Two annular manifolds 78 and 80 are formed in the body of the substrate holder 20 under the recess 26. Both manifolds are connected on one side to the source of supply of the heating/cooling or cleaning liquid from the storage of this liquid (not shown) and on the other side with respective channels 76a, 76b, 76c and 74a, 74b, 74c. In FIG. 2, channels 84 and 86, which connect the valve 82 with manifolds 78 and 80, respectively, are shown conventionally, and in a real construction these channels will be formed in the shaft 28 (FIG. 1).

The aforementioned sets of vortex generation openings 70a, 70b, 70c and 72a, 72b, 72c operate in an alternating manner, so that when vortexes are generated in the openings 70a, 70b, and 70c, the openings 72a, 72b, 72c do not work, and the floating substrate is caused to rotate in a clockwise direction. On the other hand, when vortexes are generated in the openings 72a, 72b, and 72c, the openings 70a, 70b, 70c do not work, and the floating substrate is caused to rotate in a counterclockwise direction.

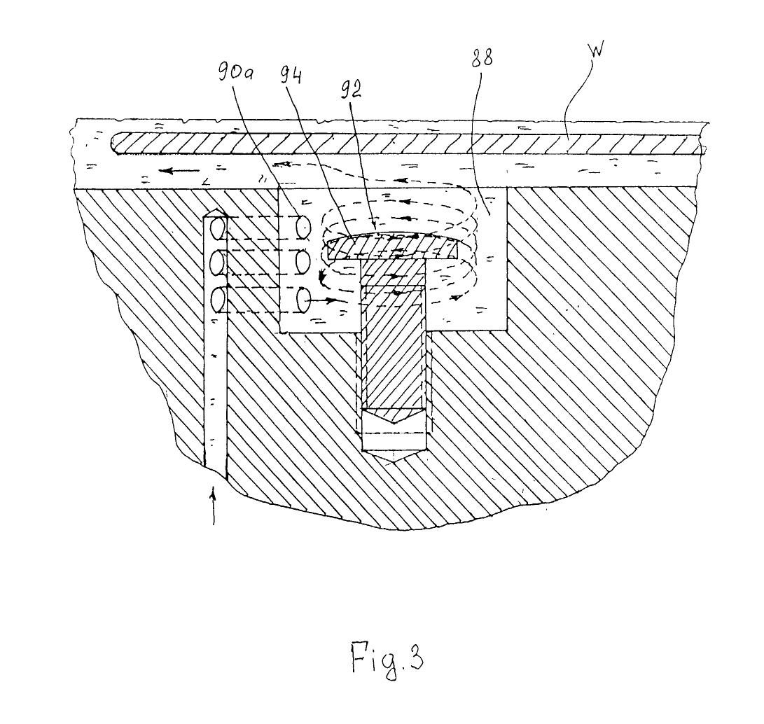

FIG. 3 illustrates another form of a vortex generation opening 88, which in addition to liquid ejection nozzles 90a of the type shown and described above, is provided with a pressure control mechanism 92 in the form of a screw with a flat head 94 threaded into the bottom of the opening 88. When the head 94 is raised up by unscrewing the screw 92, the pressure of the working/heating/cooling or cleaning liquid in the opening 88 is reduced in the area of the head 94 due to viscous friction developed by the liquid on the surface of the head 84. By descending the head 94, the areas of reduced pressure in the center of the opening 88 is increased. This adjustment makes it possible to control a force applied from the vortex to the substrate W.

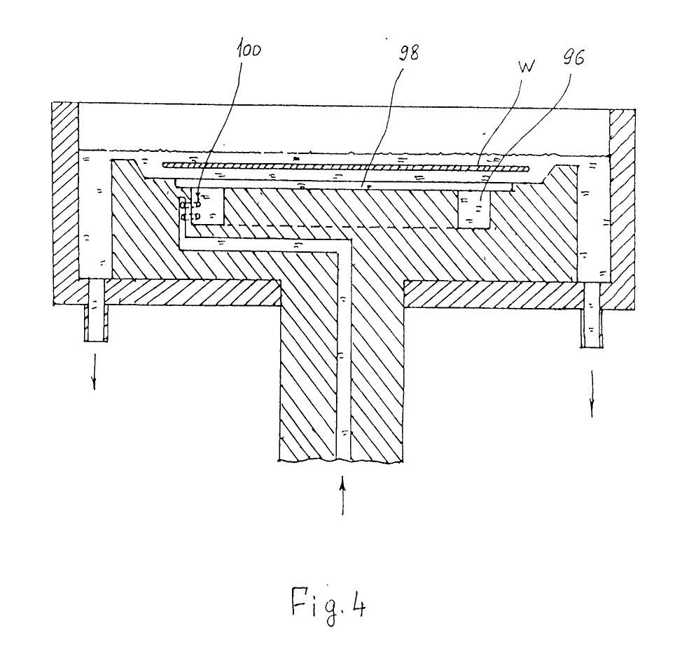

FIG. 4 shows another embodiment of a vortex generation mechanism in the form of an annular groove 96 with an outer diameter only slightly smaller than the diameter of the recess 98. The outer side wall of the annular groove 96 is provided with liquid ejection nozzles of two types. Nozzles 100 are oriented so that the liquid ejected from these nozzles causes rotation of the floating substrate W in one direction, while nozzles 102 are oriented so that the liquid ejected from these nozzles causes rotation of the floating substrate W in the opposite direction. By switching the supply of the liquid from nozzles 100 to the nozzles 102, it is possible to change the direction of rotation of the floating substrate W.

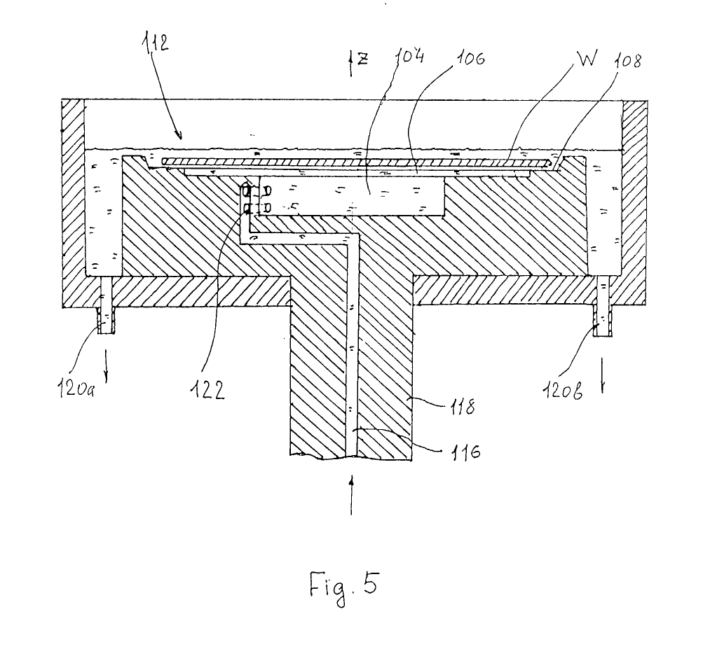

FIG. 5 is a side sectional-view of the apparatus according to another embodiment of the invention, in which a blind cylindrical opening 104 is provided in the center of a recess 106 formed in the substrate-supporting surface 108 of the substrate holder 110. The latter is located in a processing chamber 112, e.g., of an electroless deposition apparatus (not shown). Reference numeral W designates a substrate.

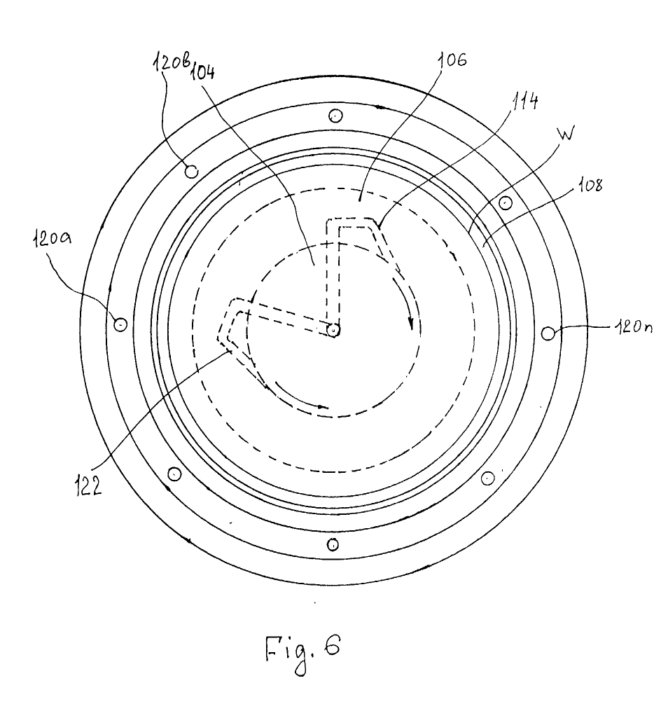

FIG. 6 is a top view of the device of FIG. 5. A liquid-ejection nozzle 114, which is arranged tangentially to the wall of the opening 104, is formed in the body of the substrate holder 110. The nozzle 114 is connected with a liquid supply channel 116 formed in the shaft 118. The liquid is removed from the processing chamber through outlet openings 120a, 120b, . . . 120n formed in the bottom of the chamber and connected to the return line of the system (not shown).

A nozzle 122 connected to the same liquid supply channel 116 can be formed on the diametrically opposite side of the opening 104 with direction of the jet emitted from the nozzle 122 opposite to that of the nozzle 114. This makes it possible to change direction of rotation of substrate W during treatment of the substrate in a floating state shown in FIG. 5. It is understood that in this case the system should be provided with a switch valve (not shown) for switching the supply of the liquid from one nozzle to the other. During treatment, the substrate is always submerged into the working liquid to a predetermined level.

Let us consider, e.g., with reference to the apparatus of FIG. 1, the operation of vortex generation devices and interaction of forces that cause rotation of the floating substrate during treatment accompanied by flow of the liquid that passes through the working chamber 22. Let us assume that the apparatus has only two diametrically opposite vortex generation openings 124 and 126 shown in FIG. 6, which is a schematic top view on the openings. In FIG. 6, reference numeral W1 designates a substrate shown by a dash-and-dot line.

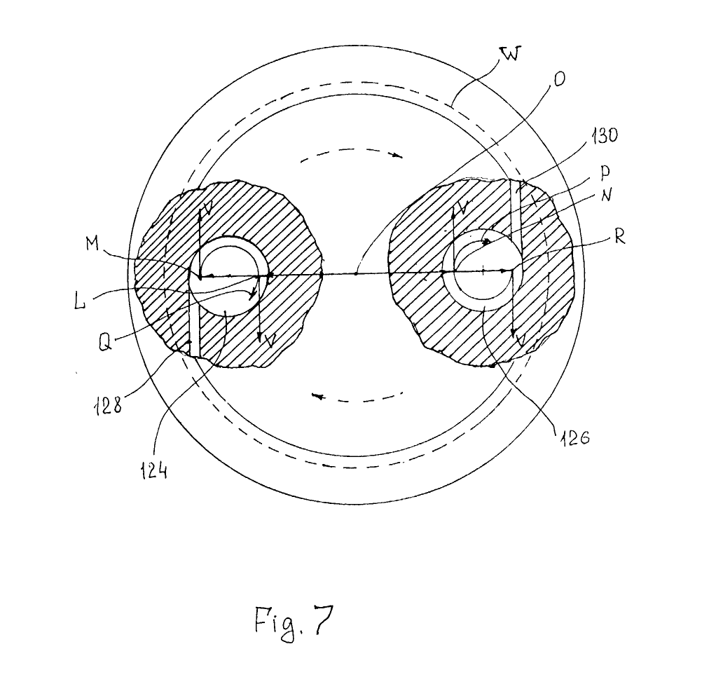

When during operation of the apparatus the liquid is ejected through a nozzle 128 tangentially into an opening 124, the liquid begins to rotate in the opening 124 in the direction of arrow Q. The same situation occurs in the opening 126, where a flow of liquid is ejected into the opening 126 through the nozzle 130, whereby the liquid begins to rotate in the direction of arrow P. Point O is a center of wafer W and of the holder 110 (FIG. 1). FIG. 7 is a top view illustrating generation of torque applied to the substrate under the effect of two vortex generation openings. It is understood from FIG. 7 that particles of the liquid in the flow of liquid rotating in the direction of arrow Q will have mutually opposite directions in points L and M and respectively in points N and R. It is also understood that the torques developed by the rotating liquid particles in points M and L, as well as in points R and N, will have opposite directions with respect to point O. In the form of vectors, this can be expressed as the following vector products:

\overline{M}_{OM}=\overline{M}_{OR}=[V×R_{OM}] (1)

\overline{M}_{OL}=\overline{M}_{ON}=[V×R_{OL}] (2)

Sum of the torques developed by the aforementioned particles with respect to point O can be expressed as follows:

$$\begin{matrix}{M}_{Σ} = {\overline{M}}_{OM} + {\overline{M}}_{OR} + {\overline{M}}_{OL} + {\overline{M}}_{ON} \\ = [ V \times ( {R}_{OM} - {R}_{OL} ) ] + [ V \times ( {R}_{OR} - {R}_{ON} ) ] \\ = 2 [ V \times ( {R}_{OM} - {R}_{OL} ) ]\end{matrix} \qquad ( 3 )$$

It is understood that the vector sum of the torques will be directed upward and perpendicular to the plane of FIG. 7. It is also understood that if viscous friction exists between the lower surface of the substrate W and the rotating flows of the liquid in the openings 62a, 62b, 62c, 62d (FIG. 1), the aforementioned torques will cause rotation of substrate W. This phenomenon is used by the inventor for rotating the substrate in a floating state in a processing liquid. As a result, it will become possible to provide uniform treatment of the substrate surfaces from all sides and without any physical contact with any parts of the apparatus. The above explanation is applicable to all embodiments described above.

A provision of the tapered bore 31 of the type shown in FIG. 1 makes it possible to stabilize position of the substrate in a floating state and to maintain it within the limits of the area where the substrate interacts with the vortex flow via viscous friction.

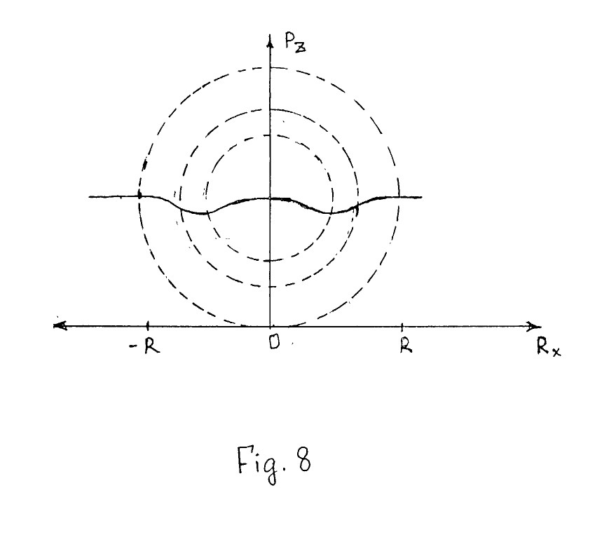

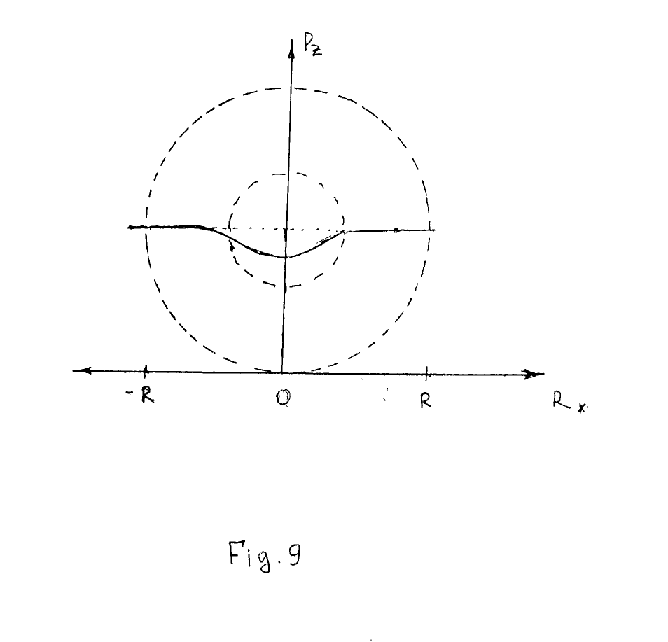

FIGS. 8 and 9 show distribution of pressure applied from the processing liquid to the lower surface of the substrate across the diameter of the substrate. FIG. 8 relates to the embodiment of FIG. 4 while FIG. 9 relates to the embodiment of FIGS. 5 and 6. It can be seen that in the vortex generation areas the pressure of the liquid under the wafer is reduced. This phenomenon facilitates maintaining of the floating substrate in equilibrium and floating state. In other words, as shown in FIG. 5, the liquid is supplied to the processing chamber 112 through the channel 116 and lifts the substrate W for spreading in the radial outward direction under the substrate surface. The liquid then passes under the edges of the substrate and flows down to the bottom of the processing chamber 112 and then is removed from the chamber 112 through the openings 120a . . . 120n in the bottom of the chamber 112. The upper surface of substrate W is always submerged into the liquid, while during the supply of the liquid the lower surface of the substrate W is always lifted above the bottom of the recess 106 under the effect of the incoming flow and the Archimedes forces (FIG. 5). It is important to note that during treatment the substrate is suspended and rotates substantially under laminar conditions of the flows with a balance between the forces acting from above and from below the substrate.

As shown in the embodiment of FIG. 2, and which is true for all embodiments, by changing directions of flows in the vortex generation openings or by switching the flows between different openings, it is possible to change the direction of liquid flows and hence the rotation of the substrate.

It has been shown that the invention provides a method and apparatus for processing objects in fluids without physical contact of the object with any parts of the apparatus during treatment. The objects are treated uniformly from all sides without the use of high-pressure jets of liquids aimed at the surfaces of the treated object and without discontinuity of flows in the working medium. The invention provides a simple and inexpensive mechanism of rotation of the objects during treatment. The method and apparatus of the invention are applicable for the formation of super-thin coatings and without damaging delicate surface structures in the processes. Rotation is imparted to the substrate from a force generated by the same liquid medium and within the volume of the medium which is used for treatment of the substrate. In other words, the device of the invention does not use any gaseous jets or external liquid jets for acting onto the substrate for its rotation. The apparatus of the invention generates a vortex or vortexes within the working medium for rotating a substrate via viscous friction between the working medium and the surface of the substrate.

The invention has been shown and described with reference to specific embodiments, which should be construed only as examples and do not limit the scope of practical applications of the invention. Therefore any changes and modifications in technological processes, constructions, materials, shapes, and their components are possible, provided these changes and modifications do not depart from the scope of the patent claims. For example, the vortex generation means may have shapes different from those shown and described and may be formed as tapered openings. The pressure adjustment mechanisms may be formed as rods, tubes, or in the form of members with the optimized shape. The number of vortex-generation openings, the number of nozzles in each opening, and the number of liquid delivery and liquid removal channels can be different from those shown and described. The processing chambers may be sealed or opened into the atmosphere. The principle of the invention is equally applicable to various processes such as application coatings, chemical mechanical polishing with the use of a slurry, electroless deposition from a solution, cleaning, washing, rinsing, etc. if necessary, the combination of vertical and tangential flows can be used for oscillation of the substrate in a vertical direction. These oscillations can be combined with rotations.

What I claim is:

1. A method for uniform treatment of an object in a liquid and by said liquid comprising:
placing said object into said liquid;
generating a flow of said liquid within the volume of said liquid, which are capable of moving said object;
raising said object to a suspended state within said liquid under the effect of said flows;
maintaining said object in said suspended state in balance between the forces acting from above and from below said object; and
moving said object into motion in the direction of said flow within said liquid under the effect of viscous friction existing between said flows and said object; and
treating said object by said working liquid.

2. The method of claim 1, wherein said motion is rotation.

3. The method of claim 2, wherein said flow is generated by at least one vortex generation means.

4. The method of claim 3, wherein said at least one vortex generation means is provided with means for reverse, said method further comprising the step of reversing said rotation.

5. The method of claim 2, wherein said flows are generated by at least two vortex generation means having opposite directions of rotation, said at least two vortex generation means being provided with switching means for selectively supplying said liquid to one of said at least two vortex generation means, said method further comprising the step of reversing said rotation.

6. The method of claim 1, wherein said object is a semiconductor substrate.

7. The method of claim 5, wherein said object is a semiconductor substrate.

8. The method of claim 1, further comprising the step of adjusting a pressure of said liquid in said flow.

9. The method of claim 8, further comprising the step of adjusting a pressure of said liquid in said flow.

10. The method of claim 1, wherein said treatment is selected from the group consisting of electroless plating, chemical mechanical polishing, application of a coating material, washing, rinsing, and cleaning.

11. The method of claim 5, wherein said treatment is selected from the group consisting of electroless plating, chemical mechanical polishing, application of a coating material, washing, rinsing, and cleaning.

12. An apparatus for uniform treatment of an object in a working liquid comprising:
a working chamber having means for the supply of said working liquid and for filling said working chamber with said working liquid to a predetermined level, said working chamber having a bottom for supporting said object in a position which is below said predetermined level when said object rests on said bottom, said object having dimensions;
a recess formed in said bottom, said recess having dimensions smaller than said dimensions of said object; and
at least one liquid flow generation means formed in said bottom and connected to said means for the supply of said working liquid, said liquid flow generation means generating a flow of said working liquid within the volume of said working liquid, said flow having a direction and being sufficient to raise said object to a suspended state in said working liquid and to interact with said object via a viscous friction for putting said object into movement, said movement having a direction.

13. The apparatus of claim 12, wherein said liquid flow generation means is at least one vortex generation means, said vortex having a direction, and said movement of said object is rotation in said direction of said movement, said rotation having a center of rotation.

14. The apparatus of claim 13, wherein said at least one vortex generation means comprises:
at least one round opening formed in said recess and having a cylindrical wall; and
at least one nozzle connected to said means for the supply of said working liquid, said at least one nozzle being open into said round opening and being arranged tangentially to said cylindrical wall so that when working liquid is ejected into said round opening, said working fluid flows in a circular path in said round opening and thus creates a vortex.

15. The apparatus of claim 14, wherein said at last one opening is selected from the group consisting of an annular groove, an opening in the center of said rotation, and an opening located outside said center of rotation but within the limits of said dimensions of said object.

16. The apparatus of claim 15, wherein said vortex generation means having means for adjusting pressure of said working liquid in said vortex.

17. The apparatus of claim 16, wherein said means for adjusting pressure comprise a screw threaded with a head, a position of said head with respect to said object in said suspended state can be adjusted by screwing or unscrewing said screw.

18. The apparatus of claim 15, comprising at least two vortex generation means having said nozzles arranged in opposite directions for changing said direction of said rotation, said at least two vortex generation means being provided with switching means for selectively supplying said liquid to one of said at least two vortex generation means.

19. The apparatus of claim 12, wherein a tapered bore exceeding said dimensions of said recess is formed in said working chamber above said recess for stabilization of the position of said object in a floating state.

20. The apparatus of claim 14, wherein a tapered bore exceeding said dimensions of said recess is formed in said working chamber above said recess for stabilization of the position of said object in a floating state.

21. The apparatus of claim 15, wherein a tapered bore exceeding said dimensions of said recess is formed in said working chamber above said recess for stabilization of the position of said object in a floating state.

22. The apparatus of claim 18, wherein a tapered bore exceeding said dimensions of said recess is formed in said working chamber above said recess for stabilization of the position of said object in a floating state.

23. The apparatus of claim 12, wherein said object is a semiconductor substrate.

24. The apparatus of claim 14, wherein a tapered bore exceeding said dimensions of said recess is formed in said working chamber above said recess for stabilization of the position of said object in a floating state.

25. The apparatus of claim 15, wherein a tapered bore exceeding said dimensions of said recess is formed in said working chamber above said recess for stabilization of the position of said object in a floating state.

26. The apparatus of claim 18, wherein a tapered bore exceeding said dimensions of said recess is formed in said working chamber above said recess for stabilization of the position of said object in a floating state.

27. An apparatus for uniform treatment of a semiconductor substrate in a working liquid comprising:
a working chamber having a channel for the supply of said working liquid and for filling said working chamber with said working liquid to a predetermined level, said working chamber having a bottom for supporting said substrate in a position which is below said predetermined level when said substrate rests on said bottom, said substrate having a substrate diameter;
a recess formed in said bottom, said recess having dimensions smaller than said substrate diameter;
at least one vortex generation opening formed in said bottom and connected to said means for the supply of said working liquid, said vortex generation opening generating a vortex of said working liquid within the volume of said working liquid, said vortex having a direction and being sufficient to raise said substrate to a suspended state in said working liquid and to interact with said substrate via a viscous friction for putting said substrate into rotation, said rotation having a direction.

28. The apparatus of claim 27, wherein said liquid flow generation means is at least one vortex generation means, said vortex having a direction, and said movement of said object is rotation in said direction of said movement, said rotation having a center of rotation.

29. The apparatus of claim 11, wherein said at least one vortex generation opening comprises:
at least one round opening formed in said recess and having a cylindrical wall; and
at least one nozzle connected to said means for the supply of said working liquid, said at least one nozzle being open into said round opening and being arranged tangentially to said cylindrical wall so that when working liquid is ejected into said round opening, said working fluid flows in a circular path in said round opening and thus creates a vortex.

30. The apparatus of claim 29, wherein said at last one opening is selected from the group consisting of an annular groove, an opening in the center of said rotation, and an opening located outside said center of rotation but within the limits of said substrate diameter.

31. The apparatus of claim 30, wherein said vortex generation opening having means for adjusting pressure of said working liquid in said vortex.

32. The apparatus of claim 31, wherein said means for adjusting pressure comprise a screw threaded with a head, a position of said head with respect to said substrate in said suspended state can be adjusted by screwing or unscrewing said screw.

33. The apparatus of claim 30, comprising at least two vortex generation openings having said nozzles arranged in opposite directions for changing said direction of said rotation, said at least two vortex generation openings being provided with switching means for selectively supplying said liquid to one of said at least two vortex generation openings.

34. The apparatus of claim 27, wherein a tapered bore exceeding said substrate diameter is formed in said working chamber above said recess for stabilization of the position of said substrate in said suspended state.

35. The apparatus of claim 29, wherein a tapered bore exceeding said dimensions of said recess is formed in said working chamber above said recess for stabilization of the position of said substrate in said suspended state.

36. The apparatus of claim 13, wherein a tapered bore exceeding said dimensions of said recess is formed in said working chamber above said recess for stabilization of the position of said substrate in said suspended state.

37. The apparatus of claim 33, wherein a tapered bore exceeding said dimensions of said recess is formed in said working chamber above said recess for stabilization of the position of said substrate in said suspended state.

38. The apparatus of claim 29, wherein a tapered bore exceeding said dimensions of said recess is formed in said working chamber above said recess for stabilization of the position of said substrate in said suspended state.

39. The apparatus of claim 30, wherein a tapered bore exceeding said dimensions of said recess is formed in said working chamber above said recess for stabilization of the position of said substrate in said suspended state.

40. The apparatus of claim 33, wherein a tapered bore exceeding said dimensions of said recess is formed in said working chamber above said recess for stabilization of the position of said substrate in said suspended state.
